(19) United States
(12) Patent Application Publication
(10) Pub. No.: US 2006/0089169 A1
(43) Pub. Date: Apr. 27, 2006

(54) Method and system of providing cellular/WLAN dual mode telecommunication services

(76) Inventors: Shiao-Li Tsao, Hsinchu (TW); Hung-Chi Hsu, Hsinchu (TW); Chien-Chan Hsu, Hsinchu (TW)

Correspondence Address: RABIN & BERDO, P.C., Suite 500, 1101 14 Street N.W., Washington, DC, 20005, US

(21) Appl. No.: 11/038,169

(22) Filed: Jan. 21, 2005

(30) Foreign Application Priority Data
Oct. 26, 2004 (TW) 93132400

(51) Int. Cl. H04M 1/00

(52) U.S. Cl. 455/552.1; 455/422.1

(57) ABSTRACT

A method and a system of providing cellular/wireless network dual mode communication services are provided. The wireless network interface normally stays in the standby mode, and the cellular interface is closed. When receiving calls, the cellular system receives the calls and wakes up the wireless network system to communicate to the calls. Hence, the power consumption of the dual mode phone is minimized.

### BACKGROUND OF THE INVENTION

1. Field of Invention

The invention relates to a control system and the corresponding method of providing telecommunication services. More particularly, the invention relates to a telecommunication service system with cellular/wireless network dual mode communications.

2. Related Art

The rapid development of wireless networks (such as 802.11 or 802.16) has direct impacts on mobile communication markets. People generally believe that the combination of wireless networks such as 802.11/WLAN and 802.16/WiMAX and voice over IP (VoIP phone will be an important application. Providing VoIP or IP phone services on wireless network has many benefits for users. In addition to a cheaper fee, cellular phone interference equipment (e.g. the medical industry) is also relieved.

In recent years, many cellular communication service providers integrate cellular and wireless network facilities because it enjoys the advantages of both wireless technologies. Wireless network such as WLAN has a high speed and an effective range of 300 meters, suitable for downloading huge data. The effective range of the cellular network covers a wider area, as far as one to several miles. However, its downloading speed can only reach 50 kbps to 100 kbps.

The wireless network, for example WLAN, is much cheaper than the cellular communication network. Using the existing WLAN structure can save a lot of development grant and avoid the electromagnetic wave problems. Therefore, it is healthier. Although this technology is far reaching, it still requires a lot of key integration techniques. Unlike the cellular communication network, which communicates with base stations every few seconds, the WLAN has to communicate every few microseconds. Therefore, it consumes a lot of power. Moreover, there is no integration between the cellular and WLAN communications. People still adopt the method of using two phone numbers. Thus, it is practically inconvenient.

### SUMMARY OF THE INVENTION

In view of the foregoing, an objective of the invention is to provide a system and a method of providing cellular/wireless network dual mode telecommunication services. Not only does the invention have both the dual mode cellular and wireless network communication services, it also minimizes the power consumption of the system.

To achieve the above objective, the disclosed system and method of providing cellular/wireless network dual mode communication services normally keeps the cellular interface standby but shuts down the wireless network interface. When receiving calls, the cellular system receives the calls and wakes up the wireless network system to accept the calls. Hence, the power consumption of the dual mode phone is minimized.

The disclosed method of providing cellular/wireless network dual mode communication services calls a representative number from a calling source to receive a call signal. In addition to the original phone numbers of the dual mode mobile in cellular network and wireless network, we assign a new dual mode representative number to a user. Calling to this new dual mode number can be processed by the presented invention methods. Different calling sources determine communications with the registrars of a dual mode phone via a gateway or an SIP(Session Initiation Protocol) proxy. After obtaining the numbers associated with the wireless network interface and the cellular interface, the calling signal is transmitted simultaneously to both the wireless network and the cellular communication services. The purpose of transmitting the signal to the cellular network is not to establish a connection with the receiver via this channel. It is solely used to wake up the wireless network communication via the cellular network to establish a connection with the calling source. Since the wireless network is normally in sleep mode, there is no power consumption problem. Using the cellular network to wake up the wireless network can ensure that the call is not lost. The user can enjoy the convenience of both cellular and wireless network communication services.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of calling using a cellular network according to the invention;

FIG. 2 is a schematic view of calling using a wireless network according to the invention;

FIGS. 3-5 are schematic views of an embodiment showing how the invention receives a call;

FIGS. 6 and 7 are schematic view showing the power consumption of the invention in simulations;

FIG. 8 is a schematic view of location updates during simulations of the invention;

FIG. 9 is a schematic view of the power consumption in the simulations of FIG. 8; and

FIG. 10 is a schematic view of the connection time in the simulations of FIG. 8.

### DETAILED DESCRIPTION OF THE INVENTION

The disclosed system and method of providing cellular/wireless network such as 802.11/WLAN or 802.16/WiMAX dual mode telecommunication services is used in a dual mode phone with both the personal communication system (PCS) and the wireless network interfaces. For best explanation of the proposed technique, WLAN, a wireless network technology, was selected as an example in the description below. WLAN is an example and the invention is not limited to a WLAN system. Normally, the cellular interface stays in the standby mode and the WLAN is turned off. When receiving calls, the cellular network wakes up the WLAN interface. Therefore, the invention can enjoy the advantages of dual modes without encountering the drawbacks of the serious power consumption problem of WLAN.

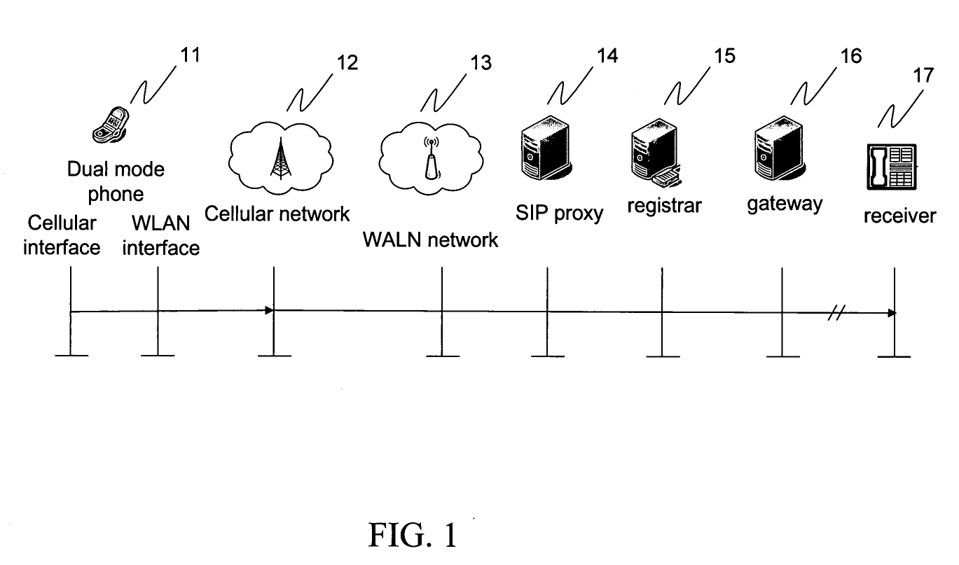

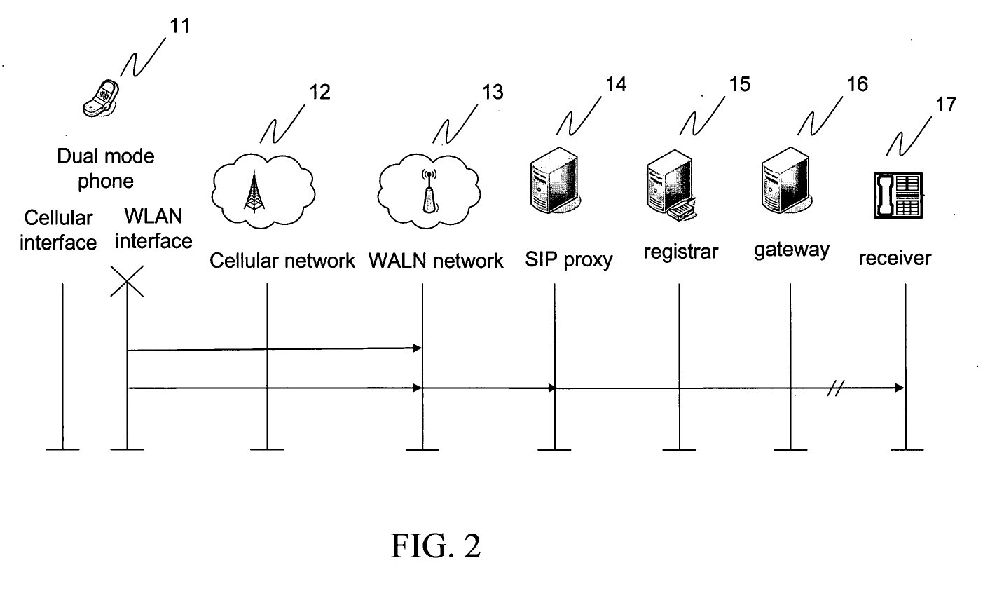

The communication service has two parts: calling and receiving. The calling part mainly depends on the requirements and habits of the user. For example, if the user wants to dial out using the cellular mode, as shown in FIG. 1, he/she calls using a dual mode phone 11 via the cellular network 12 to the receiver 17. The receiver 17 can be on a public switched telephone network (PSTN) or a cellular phone too. If the user wants to dial out using the WLAN interface, as shown in FIG. 2, he/she calls the receiver 17 using the dual mode phone 11 via the WLAN network 13. Basically, for the calling part, the WLAN interface can be turned on once the user decides what to use without any problem. We analyze in the following paragraphs only the receiving part of the dual mode phone 11.

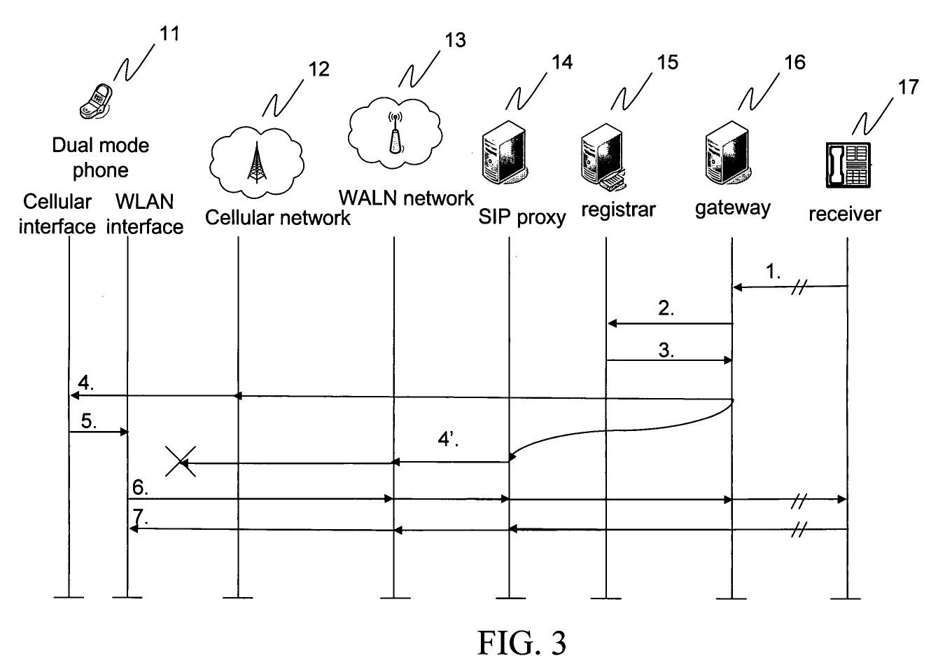

The invention designs the dual mode phone 11 in such a way that a new dual mode representative number is assigned to the dual mode mobile. Calling to this new dual mode number can be processed by the presented invention methods. An external calling source 17 only needs to call this representative number. According to different calling sources 17, different exchange mechanisms will be used. With reference to FIG. 3, if the calling source 17 is a public switched telephone network (PSTN) or a cellular phone (cellular network), the system receives the calling signal via a gateway 16 and acquires the registrar 15 of the dual mode phone, obtaining the numbers of the WLAN communication and the cellular network represented by the representative number. It further uses the gateway 16 to send the calling signal to the WLAN and cellular communications of the dual mode phone 11. In this case, since the WLAN normally stays in the sleep mode, thus it cannot receive this calling signal. The cellular communication can receive this call and wakes up the WLAN interface, making it to establish connections with the calling source 17 via the WLAN network 13, the SIP proxy 14, and the gateway 16.

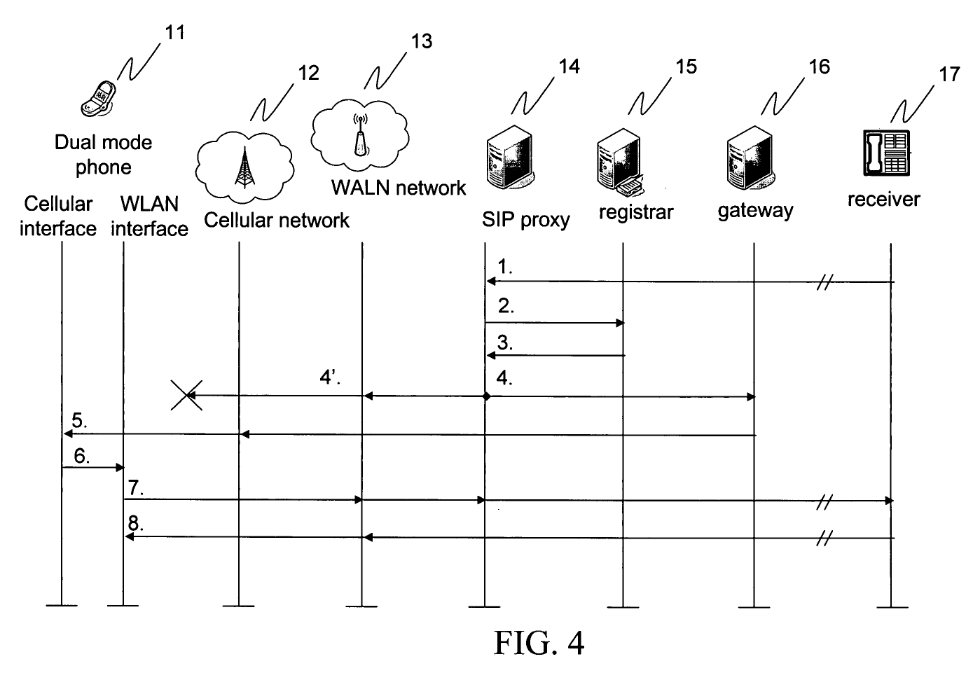

If the calling source 17 is an IP phone, as shown in FIG. 4, the transmitted calling signal is received directly by the SIP proxy 14. The registrar 15 of the dual mode phone is inquired to obtain the numbers of the WLAN and cellular network represented by the representative number. In this case, the WLAN number is called via the WLAN. Since the WLAN interface is normally turned off, this call cannot be received. The cellular network number has to be sent via the gateway 16 to the dual mode phone 11 via the cellular network 12. This call can be received by the cellular interface, which then wakes up the WLAN interface to establish a connection with the SIP proxy 14 via the WLAN network 13.

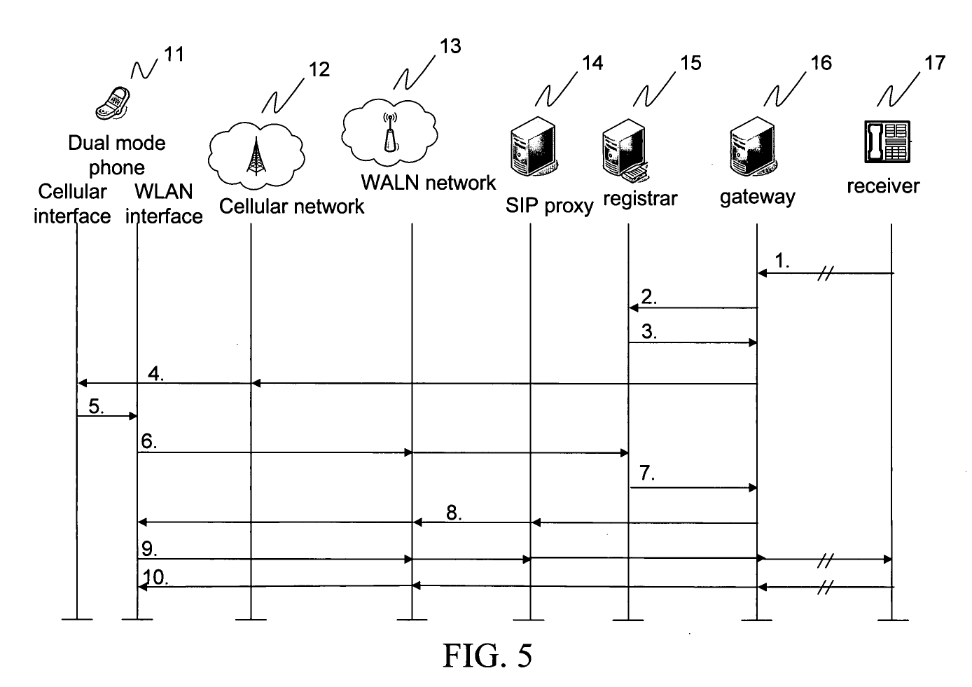

In the above embodiment, the method sends calling signal to both the cellular and WLAN interfaces simultaneously and wakes up the WLAN to receive the calling signal. As shown in FIG. 5, one can simply call the cellular network number without calling both simultaneously. On the other hand, if the WLAN interface of the dual mode phone 11 is not registered, the situation becomes similar to the above-mentioned case because one can only retrieve the cellular network number when inquiring the dual mode phone registrar 15 for the number corresponding to the representative number. Therefore, the calling signal is sent via the cellular communication service, which then wakes up the WLAN interface. Afterwards, the dual mode mobile registers its WLAN interface at the dual mode phone registrar 15 and verifies at the gateway 16. After the registration, the gateway forwards the call to the dual mode mobile via the WLAN interface.

For a user or a caller, he/she only needs to memorize one representative number for the interface. Since the cellular network is normally standby, there is no problem of missing any phone call. When a call is received, the WLAN is waked up by the cellular network to establish a connection with the calling source. Therefore, the standby power consumption of the cellular/WLAN dual mode mobile is much lower. In the following, we perform a simulation analysis with regard to the power consumption and the waking time, illustrating that the disclosed method indeed achieves the claimed effects.

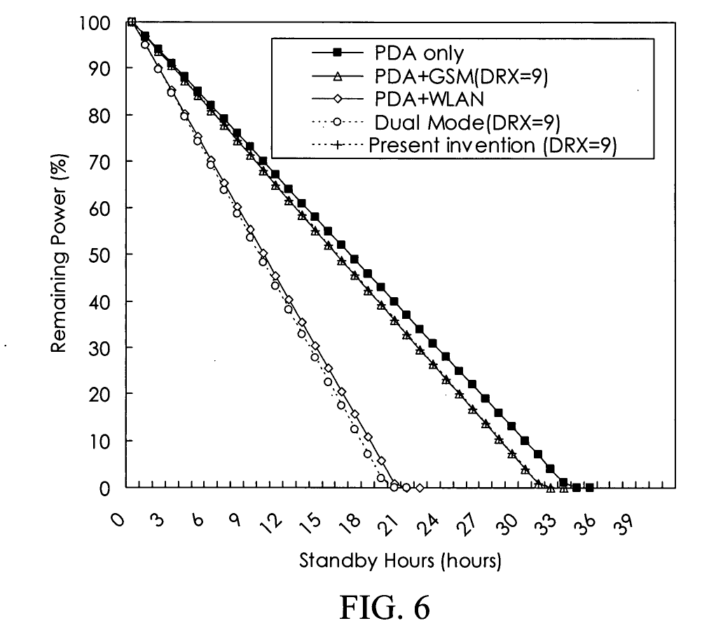

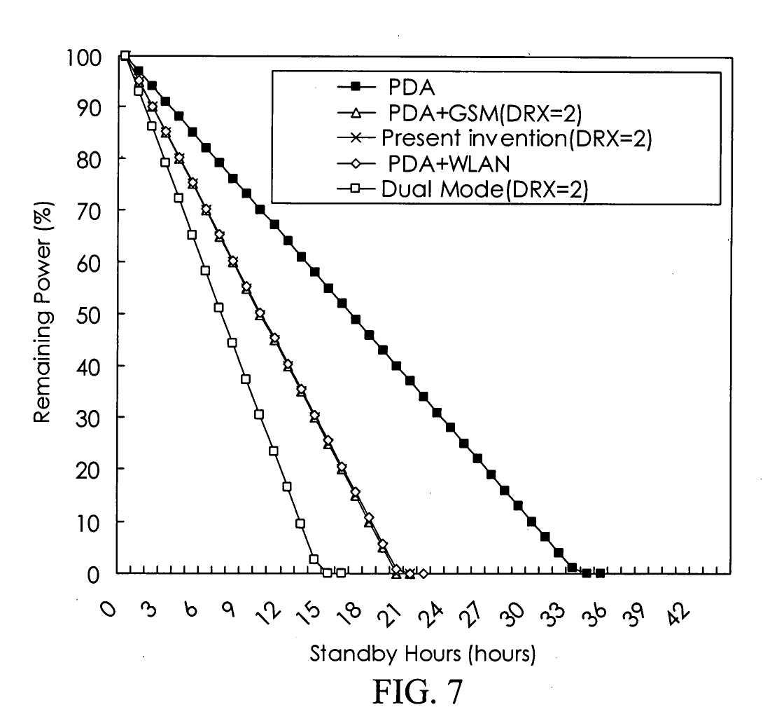

With reference to FIG. 6, a simple personal digital assistant (PDA) is most power efficient because it does not have the communication interfaces. The conventional dual mode phone consumes the most power because the WLAN communication is normally turned on. When the PDA is combined with the GSM cellular interface, the power consumption increases a little. However, if the WLAN interface is further included, the power consumption is greatly increased, to an extent close to the conventional dual mode phone. The dual mode phone using the disclosed method basically turns on the WLAN interface only when an incoming call is received. Therefore, its power consumption is very close to the PDA plus GSM mode. Simulation results show that the invention can improve the power consumption by 60% than a conventional dual mode phone. In these simulations, the discontinuous receive (DRX) of the GSM system is 9. When DRX being adjusted to 2, as shown in FIG. 7, the power consumption of the GSM part increases, rendering a 40% improvement than the prior art.

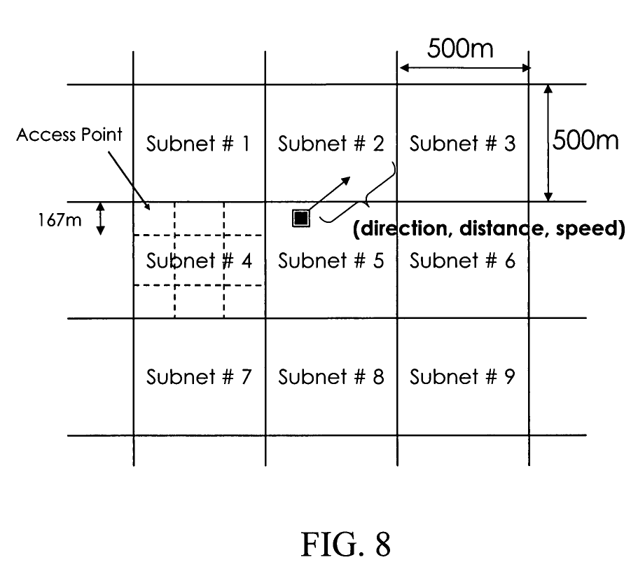

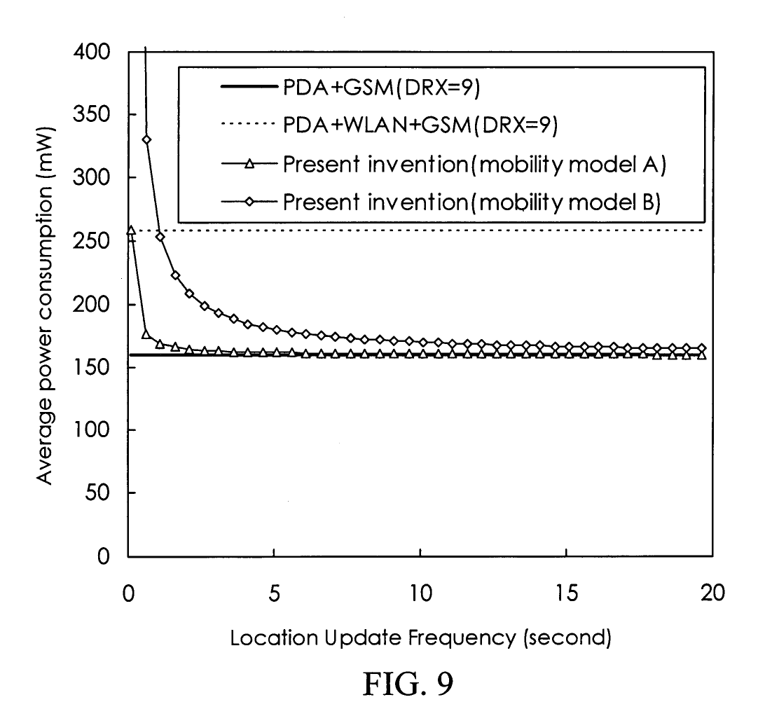

For further verification, please refer to FIG. 8. Generally speaking, a subnet can service a 500 m*500 m area. Each access point in the region is about 167 m*167 m. Therefore, as a user moves from one access point to another within the area, a new connection has to be established. He/she needs to register again when crossing different subnets. Therefore, either re-login or re-registration affects the power consumption and connection time. At the same time, users in fixed regions (e.g. engineers, mobility mode A) and users with high moving speeds (e.g. salespersons, mobility mode B) are defined according to the commonly usage models. In FIG. 9, we show a schematic view of how power consumption varies with the location update rate. Since the conventional method keeps the system on all the time, the location update does not affect the power consumption. However, the mode A and mode B in the invention have large power consumption when the location update rate is high. However, once the location update rate becomes low, the power consumption gets closes to the pure PDA+GSM.

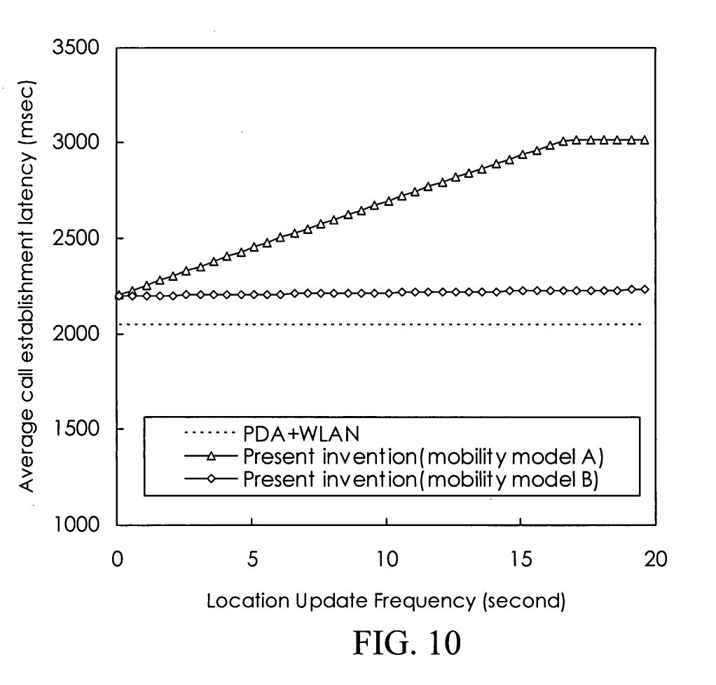

With reference to FIG. 10, as the location update rate gets low, the connection time increases. Therefore, even though lowering the location update rate helps reducing the power consumption, the update connection time is extended. Thus, a preferred scheme is to find a balance point for both saving energy and keeping a short connection time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of providing cellular/wireless network dual mode communication services for a communication system with a representative number and having the dual modes of personal communication system (PCS) and wireless network, comprising the steps of:
receiving a calling signal from a calling source;
transmitting the calling signal to the cellular network;
waking up the wireless network interface using the cellular network; and
establishing a communication with the calling source via the wireless network.

2. The method of claim 1, wherein the calling source is selected from the group consisting of the public switched telephone network (PSTN) and the cellular network.

3. The method of claim 1, wherein the calling source is an IP phone.

4. The method of claim 1, wherein the step of receiving a calling signal from a calling source is followed by the step of obtaining the number of the cellular network.

5. The method of claim 4, wherein the number of the cellular network is obtained from a dual mode phone registrar.

6. The method of claim 1, wherein the step of receiving a calling signal from a calling source is followed by the step of obtaining the numbers of the cellular network and the wireless network.

7. The method of claim 6, wherein the numbers of the cellular network and the wireless network are obtained from a dual mode phone registrar.

8. The method of claim 6, wherein the step of transmitting the calling signal to the cellular network is achieved by simultaneously transmitting the calling signal to the cellular network and the wireless network using the obtained cellular network number and the wireless network number.

9. The method of claim 1, wherein the step of waking up the wireless network using the cellular network is followed by the step of registering at a dual mode cellular registrar using the wireless network.

10. A system of providing cellular/wireless network dual mode communication services, comprising:
a dual mode phone with the dual modes of the PCS and the wireless network and using one representative number to represent a cellular network number and a wireless network number;
a dual mode phone registrar for managing the dual mode phone;
an exchange mechanism for communicating with the dual mode phone registrar; and
a calling source to call the representative number by sending a calling signal and to obtain the cellular network number represented by the representative number from the dual mode phone registrar via the exchange mechanism, thereby sending the calling signal to the cellular network service of the dual mode phone; wherein the cellular communication interface wakes up the wireless network interface to register its availability to gateway; the gateway forward the incoming call to the dual mode mobile and to establish a connection with the calling source via the exchange mechanism.

11. The system of claim 10, wherein the calling source is selected from the group consisting of the public switched telephone network (PSTN) and the cellular network.

12. The system of claim 11, wherein the exchange mechanism is a gateway.

13. The system of claim 10, wherein the calling source is an IP phone.

14. The system of claim 13, wherein the exchange mechanism is an SIP proxy.
